(19) United States
(12) Patent Application Publication
(10) Pub. No.: US 2017/0332033 A1
(43) Pub. Date: Nov. 16, 2017

(54) FAST ACCESS TO INTERNET APPS WITH A REMOTE CONTROL

(71) Applicant: THOMSON LICENSING, Issy-les-Moulineaux (FR)

(72) Inventor: Minqing XING, Carmel, IN (US)

(73) Assignee: THOMSON LICENSING, Issy-les-Moulineaux (FR)

(21) Appl. No.: 15/520,718

(22) PCT Filed: Oct. 12, 2015
(86) PCT No.: PCT/US2015/055111

§ 371 Date: Apr. 20, 2017

Related U.S. Application Data
(60) Provisional application No. 62/083,361, filed on Nov. 24, 2014.

(51) Int. Cl. H04N 5/44; H04N 21/422; H04N 21/4363; H04N 21/61; H04N 21/8545

(52) U.S. Cl. CPC H04N 5/4403; H04N 21/6125; H04N 21/8545; H04N 21/42204; H04N 21/43635; H04N 2005/4412

(57) ABSTRACT

A method and apparatus for fast access to internet applications (apps) using a remote control is disclosed herein. The method includes accessing a web app group, selecting an app from the web app group, adding the selected app to an input list, and accessing the selected app via an input button on the remote control.

### FIELD OF INVENTION

This application is in the field of displaying an input select menu containing a list of video inputs available to a display device.

### BACKGROUND

Modern televisions, video projectors, and other display devices typically have graphical user interfaces (GUIs) that can be displayed and navigated through using a remote control device or an input key. Such interfaces can be displayed on the display devices and used to establish various settings for the display devices, such as color, aspect ratio, picture quality and video input.

Display devices typically have a plurality of video input plugs for receiving video signals from a variety of different video sources, including game consoles, set-top boxes, DVD players, VCRs, DVRs, PCs, and memory cards. A video selection switch operated by user inputted commands is used to switch between the various video inputs. A conventional GUI associated with the video selection switch uses a static list of video inputs corresponding to a prearranged order of the video input plugs on the display device.

Interactive televisions often include a wide variety of applications, in turn, containing a large selection of available viewer functions. Different viewers have different use patterns, with each viewer having favorite applications or application functions. In recent years, most televisions allow the user to connect to the internet and run internet apps. However, to start an app, the user would need to first go to an internet app group, which usually starts slowly to bring up a GUI, then navigate to the app and start it. For most users who are familiar with the input key, this is very inconvenient. Accordingly, a need remains for an improved television that allows a viewer to quickly access and program favorite applications into the input menu of the television.

### SUMMARY

A method and apparatus for fast access to internet applications (apps) using a remote control is disclosed herein. The method includes accessing a web app group, selecting an app from the web app group, adding the selected app to an input list, and accessing the selected app via an input button on the remote control.

### BRIEF DESCRIPTION OF THE DRAWING(S)

FIGS. 1A and 1B are examples of remote control buttons;

FIG. 2 is an example of an input list on a display device; and

FIG. 3 is an example method of fast access to internet apps with a remote control.

### DETAILED DESCRIPTION OF THE PREFERRED EMBODIMENT(S)

It is to be understood that the figures and descriptions of embodiments have been simplified to illustrate elements that are relevant for a clear understanding of the invention, while eliminating other elements and steps that are well known in the art and do not facilitate a better understanding of the present invention.

As more televisions are providing support for internet applications (apps), fast access to the apps is becoming more important. Most televisions provide a remote control with a key for all internet apps. One advantage of this approach may be that all the apps are listed in a single group. However, the dedicated key often brings up a graphic user interface (GUI) with heavy graphics, which is slow to start. Additionally, navigating to an app may also be slow depending on the location of the app on the GUI. For example, sometimes the icon of the app may be off screen.

An efficient way for starting an app with a remote control may be described herein. The user can quickly start an app with the input key. Once the user pushes the input key on the remote control, the user can toggle through the input list (including both conventional inputs and apps) using the directional buttons.

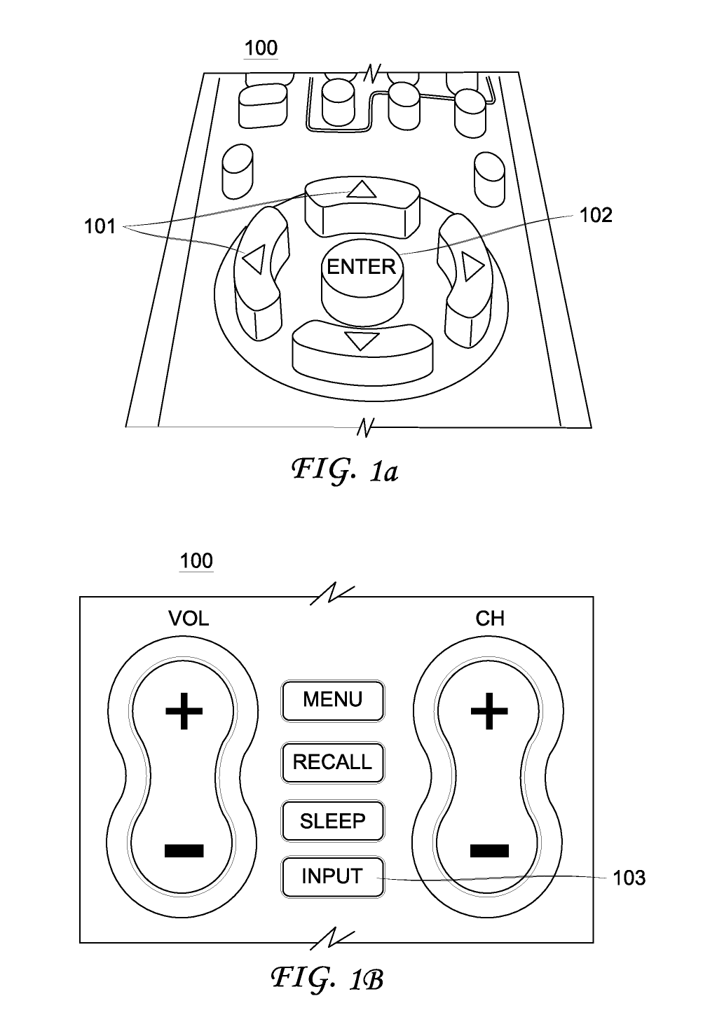

FIGS. 1A and 1B are examples of remote control buttons. FIG. 1A is an example of the directional buttons 101 and the selection button 102 on a remote control 100. FIG. 1B is an example of the input button 103 on the remote control 100.

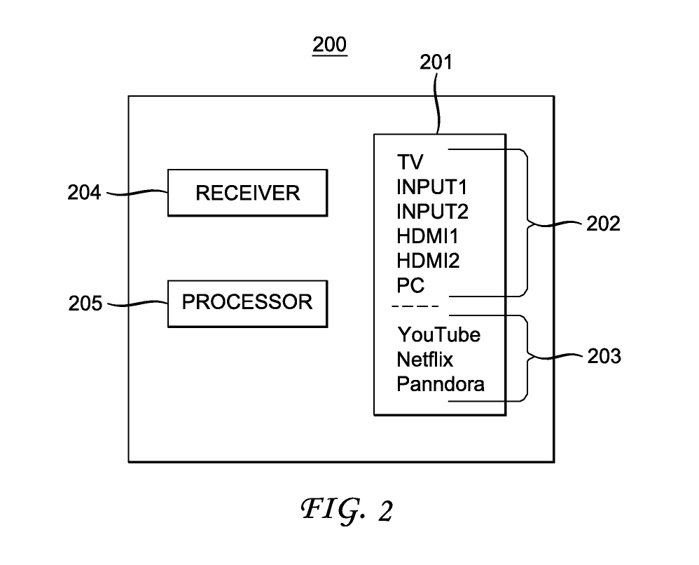

FIG. 2 is an example of an input list on a display device. The display device 200 includes a display 201, a receiver 204, and a processor 205. The display 201 includes both conventional inputs 201 and apps 202. When the user presses the input key on the remote, a list such as the one shown in FIG. 2 will pop up on the display device. While the list is showing on the display device 200, the user may keep pressing the INPUT key to toggle through every item on the list, including both the conventional inputs 101 and the apps 102 (for example, TV->INPUT1->INPUT2->HDMI1->HDMI2->PC->yOUtUBE->nETfLIX->Pandora->TV-> and so on). While the list is showing on the display device 200, the user can use the UP and DOWN arrow keys to navigate through only the conventional inputs 101 (for example, TV->INPUT1->INPUT2->HDMI1->HDMI2-PC->TV, and the like). The user can alternatively use the LEFT and RIGHT arrow keys to navigate through only the apps 102 (for example, YouTube->NetFlix->Pandora->YouTube->, and the like).

The receiver 204 may receive a first signal from a remote control to access a web group app. The processor 205 may display the web app group. The receiver 204 may receive a second signal from the remote control to select an app from the web app group and add the selected app to an input list. The processor 205 may add the selected app to the input list. The receiver 204 may receive a third signal from the remote control to access an app from the input list. The third signal may be the user pushing an input button on the remote control.

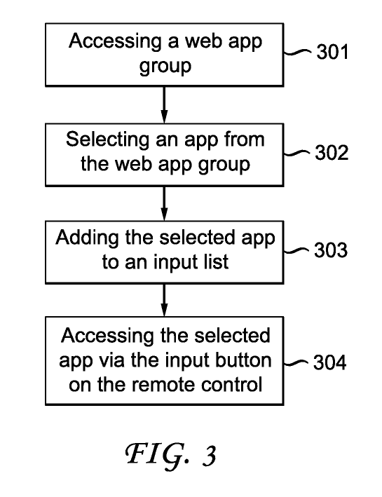

FIG. 3 is an example method of fast access to internet apps with a remote control. The user may access a web app group 301. The user may then select an app from the web app group 302 and add the selected app to the input list 303. With the apps added to the input list, the user can simply press the Input key on the remote and bring up a list of inputs and apps 304. The user can then use the up and down arrow keys to navigate the conventional input list only (for example, TV, HDMI 1, HDMI 2, HDMI 3, component, and the like) and use the left and right arrow keys to navigate the app list (for example, YouTube, Pandora, and the like).

Once the input list is brought up, the user may keep pressing the input key to navigate through all the items on the input list, including both conventional inputs and the apps. Once the user selects an app from the input list, the user is directed to the selected app. However, if there is no internet connection, the user is redirected to either the last used input or a default (for example, HDMI 1 or the like).

An internet app may be treated as a virtual input source, allowing the user to selectively put apps on the input list. The user only needs to then press the input key and selected the desired app on the list. In order to navigate among only the apps on the input list, the user can use the left and right arrow keys to skip the conventional inputs, such as TV, HDMI 1, HDMI 2, and the like.

While embodiments of the invention have been described, it will be appreciated that modifications of these embodiments are within the true spirit and scope of the invention. The invention is not limited to any particular element(s) that perform(s) any particular function(s) and some may not necessarily occur in the order shown. For example, in some cases two or more method steps may occur in a different order or simultaneously. Although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of the functions. These and other variations of the methods disclosed herein will be readily apparent, especially in view of the description of the method described herein, and are considered to be within the full scope of the invention.

1. A method for fast access to internet applications (apps) using a remote control, the method comprising:
accessing a web app group;
selecting an app from the web app group;
adding the selected app to an input list; and
accessing an app from the input list via an input button on the remote control.

2. The method of claim 1, wherein the selected app is at the bottom of an input list.

3. The method of claim 1, wherein the selected app is accessed by pushing directional buttons on the remote control.

4. The method of claim 3, wherein the directional buttons are left and right.

5. The method of claim 1, wherein a user is directed to the app when the user accesses it from the input list.

6. The method of claim 1, wherein a user is redirected to a default input on a condition that there is no internet connection.

7. The method of claim 6, wherein the default input is a last input a user was using.

8. The method of claim 6, wherein the default input is HDMI 1.

9. A display device comprising:
a receiver configured to receive a first signal from a remote control to access a web group app;
a processor configured to display the web app group;
the receiver further configured to receive a second signal from the remote control to select an app from the web app group and add the selected app to an input list;
the processor further configured to add the selected app to the input list; and
the receiver configured to receive a third signal from the remote control to access an app from the input list, wherein the third signal is an activation of an input button on the remote control.

10. The display device of claim 9, wherein the selected app is at the bottom of an input list.

11. The display device of claim 9, wherein the selected app is accessed by pushing directional buttons on the remote control.

12. The display device of claim 11, wherein the directional buttons are left and right.

13. The display device of claim 9, wherein a user is directed to the app when the user accesses it from the input list.

14. The display device of claim 9, wherein a user is redirected to a default input on a condition that there is no internet connection.

15. The display device of claim 14, wherein the default input is a last input a user was using.

16. (canceled)
